SEQUENCE LISTING (12 sequences)

SEQ ID NO: 1 - DNA, 35 bp, Artificial Sequence
  Probe 1
taacaataatccctcaaaaaaaaaaaaaaaaaaaa

SEQ ID NO: 2 - DNA, 35 bp, Artificial Sequence
  Probe 2
cacatcgtatcctagtttttttttttttttttttt

SEQ ID NO: 3 - DNA, 35 bp, Artificial Sequence
  Probe 3
ggcagctcgtggtgaaaaaaaaaaaaaaaaaaaaa

SEQ ID NO: 4 - DNA, 15 bp, Artificial Sequence
  Target 1
gagggattattgtta

SEQ ID NO: 5 - DNA, 15 bp, Artificial Sequence
  Mismatch 1-E
gaaggattattgtta

SEQ ID NO: 6 - DNA, 15 bp, Artificial Sequence
  Mismatch 1-C
gagggatgattgtta

SEQ ID NO: 7 - DNA, 15 bp, Artificial Sequence
  Mismatch 2
gaaggatgattgtta

SEQ ID NO: 8 - DNA, 15 bp, Artificial Sequence
  Noncomplementary
ggttggtgtggttgg

SEQ ID NO: 9 - DNA, 15 bp, Artificial Sequence
  Target 2
ctaggatacgatgtg

SEQ ID NO: 10 - DNA, 15 bp, Artificial Sequence
  Target 3
tcaccacgagctgcc

SEQ ID NO: 11 - DNA, 23 bp, Artificial Sequence
  Biotin DNA
aaataacaataatccctcgagcg

SEQ ID NO: 12 - DNA, 20 bp, Artificial Sequence
  Biotin DNA complement
cgctcgagggattattgtta

(19) United States
(12) Patent Application Publication
(10) Pub. No.: US 2013/0065780 A1
(43) Pub. Date: Mar. 14, 2013

(54) Label-Free Multiplexing Bioassays Using Fluorescent Conjugated Polymers and Barcoded Nanoparticles

(71) Applicants: Lin He, Newark, DE (US); Weiming Zheng, Hercules, CA (US)

(72) Inventors: Lin He, Newark, DE (US); Weiming Zheng, Hercules, CA (US)

(73) Assignee: North Carolina State University Office of Technology Transfer, Raleigh, NC (US)

(21) Appl. No.: 13/578,844

(22) PCT Filed: Feb. 14, 2011
(86) PCT No.: PCT/US11/24730

§ 371 Date: Oct. 29, 2012

Related U.S. Application Data
(60) Provisional application No. 61/304,601, filed on Feb. 15, 2010.

(51) Int. Cl. C40B 30/04; C08G 75/06; G01N 21/64

(52) U.S. Cl. 506/9; 436/501; 422/430; 525/535

(57) ABSTRACT

Label-free, multiplexed DNA assay using fluorescent conjugated polymers as a detection probe to illustrate hybridization on metallic striped nanorods are disclosed. Different DNA capture probes are encoded by the different reflectivity of Au and Ag stripe patterns. The integration of fluorescent conjugated polymers as detection moieties with metallic striped nanorods for multiplexed detection of clinically important cancer marker proteins in an immunoassay format is also provided.

### PRIORITY

This application claims priority from U.S. Provisional Application 61/304,601, filed on Feb. 15, 2010, which is hereby incorporated by reference in its entirety.

### TECHNICAL FIELD OF THE INVENTION

The present invention relates to methods for DNA hybridization detection using cationic fluorescent conjugated polymers in conjunction with barcoded nanoparticles, for example, sequence-selective nucleic acid detection. More specifically, the present invention relates to sequence-selective nucleic acid detection methods that can provide for the rapid diagnosis of infections and a variety of diseases. In addition, the present invention relates to a method of protein detection using antibodies coupled to DNA molecules that can bind cationic fluorescent conjugated polymers for signal detection. By using barcoded nanoparticles, multiplexed DNA hybridization and protein identification can be performed in mixed samples or biological fluids.

### BACKGROUND OF THE INVENTION

Biological multiplexing is one of the fastest growing areas in life science research for its potential in extracting most information from the smallest amount of sample volume at low cost. MacBeath et al. (2000) Science 289, 1760-1763; Braeckmans et al. (2002) Nat. Rev. Drug Discovery 1, 447-456; Nicewarner-Pena et al. (2001) Science 294, 137-141.

Traditional multiplexed bioassay platforms, based on either planar microarrays or suspended encoding particles, often require extra labeling steps for the targets or the probes with reporter molecules. This extra step prolongs assay times and increases assay costs. The need to overcome such hurdles has motivated development of label-free multiplexed assay systems. Progress has been made in surface plasmon resonance (SPR)-based optical detection, nanowire-based electrical or electrochemical measurements, and mass spectrometry (MS)-based high throughput screening. Homola (2008) Chem. Rev. 108, 462-493; Zheng et al. Nat. Biotenchnol. 23, 1294-1301; Koehne et al. (2004) J. Clin. Chem. 50, 1886-1893; Higgs et al. (2008) Methods Mol Biol. 428, 209-230.

Furthermore, recent progress in genomics and proteomics has demonstrated that sensitive and selective detection biomarkers are essential for diagnosis of diseases via biological multiplexing. Sander, C. Science, 2000, 287, 1977-1978; Srinivas et al. (2001) Lancet Oncol. 2, 698-704; Ferrari (2005) Nat. Rev. Cancer 161-171. In particular single nucleotide polymorphisms associated with disease states can be detected using such methods.

In particular, multiplexed protein assays are useful in diagnosing diseases such as cancer. For many types of cancers, it is insufficient to test a signal cancer marker, but rather a panel of multiple caner markers that permit diagnosis of the specific cancer subtype and treatment prognosis. See Sidransky (2002) Nat. Rev. Cancer 2, 210-219; Wulfkuhle, et al. (2003) Nat. Rev. Cancer 3, 267-275; Bidart et al. (1999) Clin. Chem. 45, 1695-1707. The use of protein markers for diagnosis requires techniques that allow rapid, multiplexed detection of many protein markers simultaneously with high sensitivity and specificity. To this end, many methods for multiplexed detection of protein markers have been developed, such as protein microarrays, fluorophore encoded microspheres, nanowire arrays, microcantilevers, electrochemical coding, metallic striped nanowires, and metal and semiconductor nanoparticle probes. See, e.g., Sreekumar et al. (2001) Cancer Res. 61., 7585-7593; Carson et al. (1999) J. Immuno. Meth. 227, 41-52; Zheng et al. (2005) Nat. Biotenchnol. 23, 1294-1301; Wu et al. (2001) Nat. Biotechnol. 2001, 19, 856-860; Liu et al. (2004) Anal. Chem. 2004, 76, 7126-7130; Tok et al. (2006) Angew. Chem. Int. Ed. 45, 6900-6904; Stoeva, et al. (2006) J. Am. Chem. Soc. 128, 8378-8379; and Jokerst et al. (2009) Biosens. Bioelectron. 24, 3622-3629. Most of these methods are expensive, complicated, have delicate assay procedures, necessitate labeling of the reporter molecules, or require sophisticated instruments for detection. Accordingly, it is desirable to develop multiplexed assay platforms that are economical and simple to perform.

Fluorescent conjugated polymers are chemical materials with electrical and optical properties that have been employed as label-free optical probes in biosensing applications. Gaylord et al. (2002) Proc. Natl Acad. Sci. 99, 10954-10957; Ho et al. (2005) Chem. Eur. J. 11, 1718-1724; Thomas et al. (2007) Chem. Rev. 107, 1339-1186. The delocalized electronic structures of these materials offer several advantages as the optical probes in biosensing schemes. The conjugated characteristics allow effective electronic coupling and efficient intra-chain and inter-chain energy transfer. Thomas et al. (2007) Chem. Rev. 107, 1339-1186. The optical properties of conjugated polymers are sensitive to minor conformational perturbations. Moreover, the collective response causes an amplification of the fluorescent signal and, therefore, can be used to report the presence of target analyte. Heeger et al. (1999) Proc. Natl. Acad. Sci. 96, 12219-12221; McQuade et al. (2000) Chem. Rev. 100, 2537-2574; Chen et al. (1999) Proc. Natl. Acad. Sci. 96, 12287-12282.

Water-soluble fluorescent conjugated polymers, characterized by their delocalized electronic structure, have been widely used as optical probes in various biosensing applications. Ho et al. (2005) Chem. Fur. J. 11, 1718-1724; Liu et al. (2004) Chem. Mater. 16, 4467-4476. For example, DNA sensors based on optically amplified Förster resonance energy transfer (FRET) from a donor conjugated polymer (polyfluorene derivates) to a signaling chromophore have been reported. Gaylord (2002) Proc. Natl Acad. Sci. 99, 10954-10957; Liu et al. (2005) Proc. Nat. Acad. Sci. 102, 589-593. U.S. Pat. No. 7,144,950 describes conformationally flexible cationic conjugated polymers that can be used in such assays and is incorporated herein by reference for such teachings. In addition, U.S. Pat. No. 7,083,928 describing detection of negatively charged polymers using water-soluble, cationic, polythiophene derivatives is also incorporated herein by reference for such teachings.

Cationic conjugated polythiophene derivatives have been used in DNA assays. Ho et al. (2002) Angew. Chem. Int. Ed. 41, 1548-1551; Doré et al. (2004) Am. Chem. Soc. 126, 4240-4244; Raymond et al. (2005) BMC Biotechnol., 5, 10; Najari et al. (2006) Anal. Chem. 78, 7896; Nilsson et al. (2003) Nat. Mater. 2, 419-426; Zheng et al. (2009) J. Am. Chem. Soc. 131, 3432-3433. In such applications, the polymers form complexes with single-stranded DNA (ssDNA) and adopt a highly conjugated, planar conformation. These conformational changes affect the electronic absorption and emission properties of the polymer. When a DNA molecule complementary to the ssDNA complexed with the polymer is added to the solution, a triplex structure is formed consisting of a double-stranded DNA and the polymer. The conformation of the polymer bound to dsDNA (i.e., a triplex) is different from that of the polymer bound to ssDNA (i.e., a duplex). As a result, the electronic absorption and emission properties change. Thus, the conformational change exhibited by the polymer in transitioning from a ssDNA-polymer complex (duplex) to a dsDNA-polymer complex (triplex) transduces DNA hybridization into detectable absorptive, fluorescent, or electrochemical signals that can be measured and quantified.

### SUMMARY OF THE INVENTION

One aspect of the present invention provides methods for detecting nucleic acid hybridization comprising: (a) combining together to form a hybridization reporter complex comprising: a nucleic acid target molecule; a nucleic acid probe; a flexible cationic conjugated fluorescent polymer; and a barcoded particle; (b) irradiating the hybridization reporter complex with light; and (c) detecting fluorescence emission to detect nucleic acid hybridization.

In some aspects, the flexible cationic conjugated fluorescent polymer is poly(1-methyl-3-[2-[(4-methyl-3-thienyl)oxy]-ethyl]-1H-imidazolium) or its derivatives. In some aspects, nucleic acid target molecule is selected from the group consisting of DNA, RNA, and a modified nucleic acid. In some aspects, nucleic acid capture probe is selected from the group consisting of DNA, RNA, and a modified nucleic acid. In some aspects, the nucleic acid target molecule is complementary to the nucleic acid probe. In some aspects, the nucleic acid target molecule, nucleic acid probe, and flexible cationic conjugated fluorescent polymer form a triplex structure. In some aspects, the nucleic acid probe covalently binds to the barcoded particle. In some aspects, the barcoded particle is striped with a plurality of metals consisting of copper, nickel, ruthenium, rhodium, palladium, silver, osmium, iridium, platinum, or gold in a predetermined pattern. In some aspects, the barcoded nanoparticles are striped with silver and gold in a predetermined pattern. In some aspects, the reporter complex is irradiated with light at 423 nm and the fluorescence emission is detected at 505 nm. In some aspects, the reporter complex is irradiated with light at 490 nm. In some aspects, the fluoresence emission can be detected by an instrument selected from the group consisting of a fluorometer, a fluorescence microscope, and a high throughput fluorescence detector, a fluorescence plate reader, an array chip scanner, and a handheld fluorescence reader. In some aspects, hybridization can be detected for a plurality of nucleic acid target molecules simultaneously. In some aspects, the nucleic acid target molecule can be quantitated. In some aspects, the nucleic acid target molecule is from a biological fluid.

Another aspect of the present invention is a method for detecting a disease state, wherein the nucleic acid target molecule comprises one or more single nucleotide polymorphisms (SNPs).

Another aspect of the present invention is a hybridization reporter complex comprising a nucleic acid target molecule; a nucleic acid probe; a flexible cationic conjugated fluorescent polymer; and a barcoded particle; wherein the nucleic acid target molecule is complementary to the nucleic acid capture probe; wherein the nucleic acid target molecule, nucleic acid capture probe, and flexible cationic conjugated fluorescent polymer form a triplex structure; wherein the nucleic acid probe covalently binds to the barcoded particle; wherein, the barcoded particle is striped with silver and gold in a predetermined pattern; and wherein the flexible cationic conjugated fluorescent polymer is poly(1-methyl-3-[2-[(4-methyl-3-thienyl)oxy]-ethyl]-1H-imidazolium) or a derivative thereof.

Another aspect of the present invention is a method for detecting a protein target, the method comprising: (a) combining together to form a protein target reporter complex comprising: a protein target; a capture protein; a protein target reporter; and a barcoded particle; (b) irradiating the protein target reporter complex with light; and (c) detecting fluorescence emission to detect the protein target.

In some aspects, the capture protein specifically binds to the protein target. In some aspects, the capture protein covalently binds to the barcoded particle. In some aspects, the protein target reporter is linked to a fluorescent reporter comprising a nucleic acid and a flexible cationic conjugated fluorescent polymer. In some aspects, the protein target reporter is linked to the fluorescent reporter through a streptavidin-biotin linkage. In some aspects, the nucleic acid and flexible cationic conjugated fluorescent polymer form a triplex structure. In some aspects, the cationic flexible fluorescent conjugated polymer is poly(1-methyl-3-[2-[(4-methyl-3-thienyl)oxy]-ethyl]-1H-imidazolium) or derivatives thereof. In some aspects, the barcoded particle is striped with a plurality of metals consisting of copper, nickel, ruthenium, rhodium, palladium, silver, osmium, iridium, platinum, or gold in a predetermined pattern. In some aspects, the barcoded nanoparticle is striped with a plurality of metals consisting of gold and silver in a predetermined pattern. In some aspects, the protein target reporter comprises an antibody, a protein receptor, a binding partner, or other protein target-specific molecule. In some aspects, the protein target reporter is an antibody specific for the protein target. In some aspects, the protein target is from a biological fluid. In some aspects, the reporter complex is irradiated with light having wavelengths between 350-500 nm and the fluorescence emission is detected at wavelengths between 400-650 nm. In some aspects, the protein target reporter complex is irradiated with light at 423 nm and the fluorescence emission is detected at 505 nm. In some aspects, the fluoresence emission can be detected by instrument selected from the group consisting of a fluorometer, a fluorescence microscope, and a high throughput fluorescence detector, a fluorescence plate reader, an array chip scanner, and a handheld fluorescence reader. In some aspects, a plurality of protein targets can be detected simultaneously. In some aspects, a protein target can be quantitated.

Another aspect of the present invention is a method for detecting a disease state, comprising the method of claim 18, wherein the protein target is selected from prostate specific antigen (PSA), carcinoembryonic antigen (CEA), or human β-chorionic gonadotropin (βhCG).

Another aspect of the present invention is a protein target reporter comprising an antibody, linked through a streptavidin-biotin linkage to a fluorescent reporter; wherein the fluorescent reporter comprises a nucleic acid and a flexible cationic conjugated fluorescent polymer; wherein the nucleic acid and flexible cationic conjugated fluorescent polymer form a triplex structure; and wherein the flexible cationic conjugated fluorescent polymer is poly(1-methyl-3-[2-[(4-methyl-3-thienyl)oxy]-ethyl]-1H-imidazolium) or a derivative thereof.

Another aspect of the present invention is a protein target reporter complex comprising a protein target, a capture protein, a protein target reporter; and a barcoded particle; wherein the capture protein comprises an antibody specific for the protein target; wherein the capture protein covalently binds to the barcoded particle; wherein, the barcoded particle is striped with silver and gold in a predetermined pattern; and wherein the protein target reporter comprises an antibody, linked through a streptavidin-biotin linkage to a fluorescent reporter; wherein the fluorescent reporter comprises a nucleic acid and a flexible cationic conjugated fluorescent polymer, wherein the nucleic acid and flexible cationic conjugated fluorescent polymer form a triplex structure; and wherein the flexible cationic conjugated fluorescent polymer is poly(1-methyl-3-[2-[(4-methyl-3-thienyl)oxy]-ethyl]-1H-imidazolium) or a derivative thereof.

Another aspect of the present invention is kit for detecting nucleic acid hybridization comprising a container comprising individual premeasured containers of reagents, the containers including at least a nucleic acid probe specific for a nucleic acid target molecule, a cationic conjugated fluorescent polymer, a barcoded particle, and instructions describing a method for detecting nucleic acid hybridization, the method comprising: (a) combining together to form a hybridization reporter complex comprising: a nucleic acid target molecule; a nucleic acid probe; a flexible cationic conjugated fluorescent polymer; and a barcoded particle; wherein the nucleic acid target molecule is complementary to the nucleic acid capture probe; wherein the nucleic acid target molecule, nucleic acid capture probe, and flexible cationic conjugated fluorescent polymer form a triplex structure; wherein the nucleic acid probe covalently binds to the barcoded particle; wherein, the barcoded particle is striped with silver and gold in a predetermined pattern; and wherein the flexible cationic conjugated fluorescent polymer is poly(1-methyl-3-[2-[(4-methyl-3-thienyl)oxy]-ethyl]-1H-imidazolium) or a derivative thereof; (b) irradiating the hybridization reporter complex with light; and (c) detecting fluorescence emission to detect nucleic acid hybridization.

Another aspect of the present invention is a kit for detecting a disease state, wherein the nucleic acid target molecule contains one or more single nucleotide polymorphisms (SNPs).

Another aspect of the present invention is a kit for detecting protein targets comprising a container comprising individual premeasured containers of reagents, the containers including at least capture a capture protein specific for the protein target, a protein target reporter, a barcoded particle, and instructions describing a method for detecting protein targets, the method comprising: (a) combining together to form a protein target reporter complex comprising: a protein target; a capture protein; a protein target reporter; and a barcoded particle; wherein the capture protein comprises an antibody specific for the protein target; wherein the capture protein covalently binds to the barcoded particle; wherein, the barcoded particle is striped with silver and gold in a predetermined pattern; and wherein the protein target reporter comprises an antibody, linked through a streptavidin-biotin linkage to a fluorescent reporter; wherein the fluorescent reporter comprises a nucleic acid and a flexible cationic conjugated fluorescent polymer, wherein the nucleic acid and flexible cationic conjugated fluorescent polymer form a triplex structure and wherein the flexible cationic conjugated fluorescent polymer is poly(1-methyl-3-[2-[(4-methyl-3-thienyl)oxy]-ethyl]-1H-imidazolium) or a derivative thereof; (b) irradiating the protein target reporter complex with light; and (c) detecting fluorescence emission to detect the protein target.

Another aspect of the present invention is a kit for detecting a disease state, wherein the protein target is selected from prostate specific antigen (PSA), carcinoembryonic antigen (CEA), or human β-chorionic gonadotropin (βhCG).

### BRIEF DESCRIPTION OF THE DRAWINGS

Scheme 1. Conceptual illustration of label-free multiplexed DNA detection using cationic, fluorescent, conjugated polythiophene derivatives and Ag/Au striped nanorods.

Table 1. SEQ ID NOs and DNA sequences.

FIG. 1. DNA detection in a label-free multiplexed format on barcoded nanorods using conjugated polymers. Left Panel. Reflectance (A, C) and fluorescence (B, D) images showed the mixture of three DNA-coated nanorods included with the target DNA T2 (SEQ ID NO: 9) only (A, B) or targets DNA T2 (SEQ ID NO: 9) and T3 (SEQ ID NO: 10) (C, D) (the scale bars are 5 μm). Right Panel. Quantitative fluorescence readouts in multiplexed DNA detection. DNA targets in the incubation solutions were labeled in x-axis, and the corresponding fluorescence readouts were recorded in y-axis. The color columns corresponded to the capture probes immobilized on different particles.

FIG. 2. (A) Specificity of label-free DNA detection on barcoded nanorods. (B) A plot of fluorescence signal intensities against the concentrations of T1 (SEQ ID NO: 4), the target DNA, detected using conjugated polymers on barcoded nanorods.

FIG. 3: TEM image of a silica-coated nanorod. The average SiO₂ thickness was 20 nm, regardless of the striping patterns.

FIG. 4. Fluorescence spectra of the conjugated polymer complexed with DNA when excited at 400 nm. The concentration of polymer was ˜600 nM in repeat units: (a) polymer only, (b) ssDNA-polymer complex, (c) dsDNA-polymer complex.

FIG. 5. Corresponding reflectance (A, C) and fluorescence (B, D) images of ssDNA/polymer-bound barcoded nanorods after hybridization with complementary target DNA (A, B) and non-complementary DNA (C, D).

FIG. 6. Corresponding reflectance (A, B) and fluorescence (C, D) images of conjugated polymer-based triplex DNA assay when none (A, C) or all three targets (B, D) were added. The scale bar in all images is 5 μm.

FIG. 7. Optical images of ssDNA-polymer duplexes bound to silica-coated nanorods after hybridization with the DNA sequences of various mutations: A, B: NC-DNA with non-complementary sequence (SEQ ID NO: 8); C, D: M2: DNA with two mutations of T1(SEQ ID NO: 7); E, F: M1C: DNA with one single mutation of T1 at the center of the sequence (SEQ ID NO: 6); G, H: M1E: DNA with one single mutation of T1 at the end of the sequence(SEQ ID NO: 5); and I, J: T1: complementary target DNA (SEQ ID NO: 4). The scale bar in all images is 5 μm.

FIG. 8. (A) Schematic illustration of protein detection on Au/Ag barcoded nanorods using fluorescent conjugated polymers. (B) Reflectance and fluorescence images of nanorods at the presence of protein target: PSA (a, b), and non-specific protein (BSA) (c, d) (Scale bars are 5 μm).

FIG. 9. Assay performance of PSA detection on the nanorods using fluorescence-conjugated polymers. (A) Fluorescence images of nanorods at the presence of PSA with concentration ranging from 0 to 10,000 ng/mL (a-g), (Scale bars are 5 μm). (B) A plot of fluorescence signal intensity against the concentration of PSA.

FIG. 10. Multiplexed detection of cancer marker proteins on barcoded nanorods using conjugated polymers. Upper Panel. Corresponding reflectance and fluorescence images showed the mixture of three antibody bound nanorods incubated with none cancer marker proteins (a, e), βhCG only (b, f), CEA and βhCG (c, g), and all three cancer marker proteins (d, h), (Scale bars are 5 μm). Lower Panel. Quantitative fluorescence readouts in the multiplexed detection of cancer marker proteins. Cancer marker proteins were labeled in x-axis, and the corresponding fluorescence readouts were recorded in y-axis. The color columns corresponded to the capture antibody coated on the different patterns of nanorods.

FIG. 11. Detection of PSA in bovine serum samples. Left Panel. Fluorescence images of anti-PSA coated nanorods incubated with (a) PBS buffer, (b) bovine serum, (c) bovine serum containing 1 ng/mL PSA, and (d) bovine serum containing 10 ng/mL PSA, (Scale bars are 5 μm). Right Panel. Corresponding fluorescence readouts from the nanorods.

FIG. 12. Multiplexed detection of cancer marker proteins from an assay carried out with bovine serum. Upper Panel. Fluorescence images of (a, d) no target, (b, e) CEA, (c, f) βhCG, (g, j) PSA and CEA, (h, k) CEA and βhCG, (i, l) all protein targets are present (Scale bars are 5 μm). Lower Panel. Quantitative fluorescence readouts in the multiplexed detection of cancer marker proteins. Cancer marker proteins were labeled in x-axis, and the corresponding fluorescence readouts were recorded in y-axis. The color columns corresponded to the capture antibody coated on the different patterns of nanorods.

FIG. 13. Assay performance of CEA detection on the nanorods using fluorescence-conjugated polymers. Upper Panel. Fluorescence images of nanorods at the presence of CEA with concentration ranging from 0 to 1000 ng/mL (a-f), (Scale bars are 5 μm). Lower Panel. A plot of fluorescence signal intensity against concentration of CEA.

FIG. 14. Assay performance of βhCG detection on the nanorods using fluorescence-conjugated polymers. Upper Panel. Fluorescence images of nanorods at the presence of βhCG with concentration ranging from 0 to 1000 ng/mL (a-f), (Scale bars are 5 μm). Lower Panel. A plot of fluorescence signal intensity against concentration of βhCG.

FIG. 15. Sensitivity detection of PSA on the nanorods carried out in bovine serum. Upper Panel. Fluorescence images of nanorods at the presence of PSA with concentration ranging from 0 to 1000 ng/mL (a-f) diluted in bovine serum, (Scale bars are 5 μm). Lower Panel. A plot of fluorescence signal intensity against concentration of PSA.

### BRIEF DESCRIPTION OF THE SEQUENCES

The Sequence Listing provides disclosure of the DNA sequences used in particular aspects of the invention.

TABLE 1
DNA Sequences and Sequence Identification Numbers

| SEQ ID | | | |
|---|---|---|---|
| NO | Name | Sequence | Description |
| 1 | Probe 1 | 5′-TAACAATAATCCCTCA₂₀-SH | Probe 1, immobilized |
| | | | to pattern 000100 |
| 2 | Probe 2 | 5′-CACATCGTATCCTAGT₂₀-SH | Probe 2, immobilized |
| | | | to pattern 01010 |
| 3 | Probe 3 | 5′-GGCAGCTCGTGGTGAA₂₀-SH | Probe 3, immobilized |
| | | | to pattern 011110 |
| 4 | Target 1 | 5′-GAGGGATTATTGTTA-3′ | Target 1, fully |
| | | | complementary to P1 |
| 5 | Mismatch 1-E | 5′-GAAGGATTATTGTTA-3′ | Single mismatch at |
| | | | one end to P1 |
| 6 | Mismatch 1-C | 5′-GAGGGATGATTGTTA-3′ | Single mismatch at |
| | | | center to P1 |
| 7 | Mismatch 2 | 5′-GAAGGATGATTGTTA-3′ | Two mismatches to P1 |
| 8 | Noncomplementary | 5′-GGTTGGTGTGGTTGG-3′ | Non complementary |
| | | | to P1 |
| 9 | Target 2 | 5′-CTAGGATACGATGTG-3′ | Target 2, fully |
| | | | complementary to P2 |
| 10 | Target 3 | 5′-TCACCACGAGCTGCC-3′ | Target 3, fully |
| | | | complementary to P3 |
| 11 | Biotin DNA | 5′-Bio-AAATAACAATAATCCCTCGAGCG-3′ | 5′-biotinylated DNA |
| 12 | Biotin DNA | 5′-CGCTCGAGGGATTATTGTTA-3′ | Complementary to |
| | complement | | biotinylated DNA |

### DETAILED DESCRIPTION OF THE INVENTION

It is to be understood that this invention is not limited to the particular methodology, devices, solutions, apparatuses described, as such methods, devices, solutions, or apparatuses can, of course, vary. It is also to be understood that particular terminology used herein is for the purpose of describing particular aspects only, and is not intended to limit the scope of the present invention.

For the purposes of this specification, unless otherwise indicated, all numbers expressing quantities, conditions, and so forth used in the specification are to be understood as being modified in all instances by the term “about.” Accordingly, unless indicated to the contrary, the numerical parameters set forth in the following specification are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a stated range of “1 to 10” should be considered to include any and all sub-ranges between, and inclusive of, the minimum value of 1 and the maximum value of 10; that is, all sub-ranges beginning with a minimum value of 1 or more, e.g., 1 to 6.1, and ending with a maximum value of 10 or less, e.g., 5.5 to 10.

It is further noted that use of the singular forms “a,” “an,” and “the” include plural references unless the context clearly dictates otherwise. Thus, for example, reference to “a cationic conjugated polymer” includes a plurality of cationic conjugated polymers, reference to “a subunit” includes a plurality of such subunits, reference to “a sensor” includes a plurality of sensors, and the like. Additionally, use of specific plural references, such as “two,” “three,” etc., read on larger numbers of the same subject less the context clearly dictates otherwise.

Terms such as “connected,” “attached,” and “linked” are used interchangeably herein and encompass direct as well as indirect connection, attachment, linkage or conjugation unless the context clearly dictates otherwise. Where a range of values is recited, it is to be understood that each intervening integer value, and each fraction thereof, between the recited upper and lower limits of that range is also specifically disclosed, along with each subrange between such values. The upper and lower limits of any range can independently be included in or excluded from the range, and each range where either, neither or both limits are included is also encompassed within the invention. Where a value being discussed has inherent limits, for example where a component can be present at a concentration of from 0 to 100%, or where the pH of an aqueous solution can range from 1 to 14, those inherent limits are specifically disclosed. Where a value is explicitly recited, it is to be understood that values that are about the same quantity or amount as the recited value are also within the scope of the invention, as are ranges based thereon. Where a combination is disclosed, each subcombination of the elements of that combination is also specifically disclosed and is within the scope of the invention. Conversely, where different elements or groups of elements are disclosed, combinations thereof are also disclosed. Where any element of an invention is disclosed as having a plurality of alternatives, examples of that invention in which each alternative is excluded singly or in any combination with the other alternatives are also hereby disclosed; more than one element of an invention can have such exclusions, and all combinations of elements having such exclusions are hereby disclosed.

Unless defined otherwise or the context clearly dictates otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods, and materials are now described.

All publications mentioned herein are hereby incorporated by reference for the purpose of disclosing and describing the particular materials and methodologies for which the reference was cited.

In describing the present invention, the following terms will be employed, and are intended to be defined as indicated below.

The terms “polynucleotide,” “oligonucleotide,” “nucleic acid” and “nucleic acid molecule” are used interchangeably herein to refer to a polymeric form of nucleotides of any length, and may comprise ribonucleotides, deoxyribonucleotides, analogs thereof, or mixtures thereof. These terms refer only to the primary structure of the molecule. Thus, the terms includes triple-, double- and single-stranded deoxyribonucleic acid (“DNA”), as well as triple-, double- and single-stranded ribonucleic acid (“RNA”). It also includes modified, for example by alkylation, and/or by capping, and unmodified forms of the polynucleotide.

Whether modified or unmodified, when a polynucleotide is used as a sensor molecule in methods as described herein, the sensor polynucleotide can be anionic (e.g., RNA or DNA), or the sensor polynucleotide may have an uncharged backbone (e.g., PNA). The target polynucleotide can in principle be charged or uncharged, although typically it is expected to be anionic, for example RNA or DNA.

More particularly, the terms “polynucleotide,” “oligonucleotide,” “nucleic acid” and “nucleic acid molecule” include polydeoxyribonucleotides (containing 2-deoxy-D-ribose), polyribonucleotides (containing D-ribose), including tRNA, rRNA, hRNA, miRNA, and mRNA, whether spliced or unspliced, any other type of polynucleotide which is an N- or C-glycoside of a purine or pyrimidine base, and other polymers containing a phosphate or other polyanionic backbone, and other synthetic sequence-specific nucleic acid polymers providing that the polymers contain nucleobases in a configuration which allows for base pairing and base stacking, such as is found in DNA and RNA. There is no intended distinction in length between the terms “polynucleotide,” “oligonucleotide,” “nucleic acid” and “nucleic acid molecule,” and these terms are used interchangeably herein.

It will be appreciated that, as used herein, the terms “nucleoside” and “nucleotide” will include those moieties which contain not only the known purine and pyrimidine bases, but also other heterocyclic bases which have been modified. Such modifications include methylated purines or pyrimidines, acylated purines or pyrimidines, or other heterocycles. The term “nucleotidic unit” is intended to encompass nucleosides and nucleotides.

The term “antibody” as used herein includes antibodies obtained from both polyclonal and monoclonal preparations, as well as: hybrid (chimeric) antibody molecules and any functional fragments obtained from such molecules, wherein such fragments retain specific-binding properties of the parent antibody molecule.

Nucleic acids that share a substantial degree of complementarity will form stable interactions with each other, for example, by matching base pairs. The terms “complementary or “complementarity” refer to the specific base pairing of nucleotide bases in nucleic acids. The phrase “perfect complementarity,” as used herein, refers to complete (100%) base paring within a contiguous region of nucleic acid, such as between a seed sequence in a siRNA and its complementary sequence in a target gene/RNA, as described herein. “Partial complementarity” or “partially complementary” indicates that two sequences can base pair with one another, although the complementarity is not 100%. As used herein, the term “complementary” is used to describe a nucleotide sequence capable of base pairing with another sequence, although the complementarity may not be 100%.

Alternatively stated, the term “complementary” with respect to two nucleotide sequences indicates that the two-nucleotide sequences have sufficient complementarity and have the natural tendency to interact with each other to form a double stranded molecule. Two nucleotide sequences can form stable interactions with each other within a wide range of sequence complementarities. Nucleotide sequences with high degrees of complementarity are generally stronger and/or more stable than ones with low degrees of complementarity, Different strengths of interactions may be required for different processes. For example, the strength of interaction for the purpose of forming a stable nucleotide sequence duplex in vitro may be different from that for the purpose of forming a stable interaction between a siRNA and a binding sequence in vivo. The strength of interaction can be readily determined experimentally or predicted with appropriate software by a person skilled in the art.

The terms “hybridize” or “hybridization,” as used herein, refer to the ability of a nucleic acid sequence or molecule to base pair with a complementary sequence and form a duplex nucleic acid structure. Hybridization can be used to test whether two polynucleotides are substantially complementary to each other and to measure how stable the interaction is. Polynucleotides that share a sufficient degree of complementarity will hybridize to each other under various hybridization conditions. Consequently, polynucleotides that share a high degree of complementarity thus form strong stable interactions and will hybridize to each other under stringent hybridization conditions. Stringent hybridization conditions are well known in the art, as described in Sambrook et al. (1989) Molecular Cloning: A Laboratory Manual, Second Edition, Cold Spring Harbor Laboratory, Cold Spring Harbor, N.Y. An exemplary stringent hybridization condition comprises hybridization in 6× sodium chloride/sodium citrate (SSC) at about 45° C., followed by one or more washes in 0.2×SSC and 0.1% SDS at 50-65° C.

The phrases and terms, “preferential binding,” “preferential hybridization,” “specificity,” or “specific” refer to the increased propensity of one biomolecule to bind to a binding partner in a sample as compared to another component of the sample.

As used herein, the term “monoclonal antibody” refers to an antibody composition having a homogeneous antibody population. The term is not limited regarding the species or source of the antibody, nor is it intended to be limited by the manner in which it is made. Thus, the term encompasses antibodies obtained from murine hybridomas, as well as human monoclonal antibodies obtained using human hybridomas or from murine hybridomas made from mice expression human immunoglobulin chain genes or portions thereof.

“Barcoded nanorods” or “barcoded nanoparticles” refers to carbon nanoparticles that have been differentially coated with nobel metals such as ruthenium, rhodium, palladium, silver, osmium, iridium, platinum, or gold. In one aspect, barcoded nanoparticles comprise metallic gold (Au) or silver (Ag) in 1 μm stripes. The striping is indicated digitally where “0” represents a 1 μm segment of Au and “1” represents a 1 μm segment of Ag. Thus, the combination of “101” would indicate a segment of Au surrounded by adjacent Ag segments on each side.

“Multiplexing” herein refers to an assay or other analytical method in which multiple analytes can be assayed simultaneously.

“Polypeptide” and “protein” are used interchangeably herein and include a molecular chain of amino acids linked through peptide bonds. The terms do not refer to a specific length of the product. Thus, “peptides,” “oligopeptides,” and “proteins” are included within the definition of polypeptide.

The present invention discloses the use of polythiophene derivatives in combination with metallically striped nanorods for multiplexed DNA detection. The striped metallic particles provide a means to differentiate the capture probes immobilized. U.S. Pat. Nos. 6,919,009, 7,045,049, and 7,225,082 describe methods for manufacturing colloidal rod particles as nano barcodes and are all incorporated herein by reference for such teachings.

In addition, the change in optical signatures of conjugated polythiophene derivatives when they bind to ssDNA or dsDNA permits specific detection of DNA hybridization events. Detection sensitivity at the attomole level has been demonstrated and single-base mutations in the target DNA sequence have been differentiated with greater than 3-fold differences in fluorescence intensities. This assay permits simultaneous monitoring of multiple biological recognition events in a label-free fashion. The label-free feature reduces assay cost by eliminating the labeling step and shortening the assay procedure. It also makes assay platform generically applicable to any assay involving DNA binding.

Another aspect of the present invention extends the label-free DNA detection assay to multiplexed protein detection. Specific proteins can be detected using antibodies that can link to DNA reporter complexes. These assays permit multiplexed detection of proteins with high sensitivity and selectivity. Three different cancer marker proteins have been detected in analytes using this method: prostate specific antigen (PSA), a prostrate cancer marker; carcinoembryonic antigen (CEA), a colorectal cancer marker; and human β-chorionic gonadotropin (βhCG), a testicular cancer marker. The analytical performance of the assay platform is described, and the simultaneous detection of multiple cancer markers in both assay buffer and undiluted bovine serum is also demonstrated. Zheng et al. (2010) J. Phys. Chem. C 114, 17829-17835.

### Identification of DNA Hybridization Using Fluorescent Conjugated Polymers and Barcoded Nanorods

Scheme 1 illustrates the overall detection strategy for one aspect of the present invention. In one aspect, Ag/Au striped nanorods of different patterns were used as the array elements where the particle identity was encoded by the difference in reflectivity of adjacent metal strips. Nicewarner-Pena et al. (2001) Science 294, 137-141; Keating et al. (2003) Adv. Mater. 15, 451-454. Barcoded nanoparticles were pre-coated with 20-nm silica to reduce fluorescence quenching from the metal surface and to provide a stable supporting layer for immobilization of DNA capture probes. Sioss et al. (2007) Langmuir 23, 11334-11341. The thiolated DNA capture probes were pre-mixed with a cationic conjugated polythiophene derivative poly(1-methyl-3-[2-[(4-methyl-3-thienyl)oxy]-ethyl]-1H-imidazolium) to form weakly fluorescent ssDNA-polymer duplexes through electrostatic interaction. The ssDNA-polymer duplexes were then covalently bound to the amino-modified silica-coated nanorods where the particles of the same pattern carried the same DNA capture probes. Assorted nanorods carrying different DNA capture probes were then mixed before incubating with a mixture of target DNA sequences. Hybridization between the capture DNA probe and the target DNA led to formation of dsDNA-polymer triplexes, for which a strong fluorescence emission at 505 nm was observed. Both reflectance and fluorescence images of the nanorod mixture were collected where the identity of the target DNA was determined by the pattern of the nanorods, i.e., the corresponding capture probe, with strong fluorescence emission and the amount of the target DNA captured was quantified based on the fluorescence intensity.

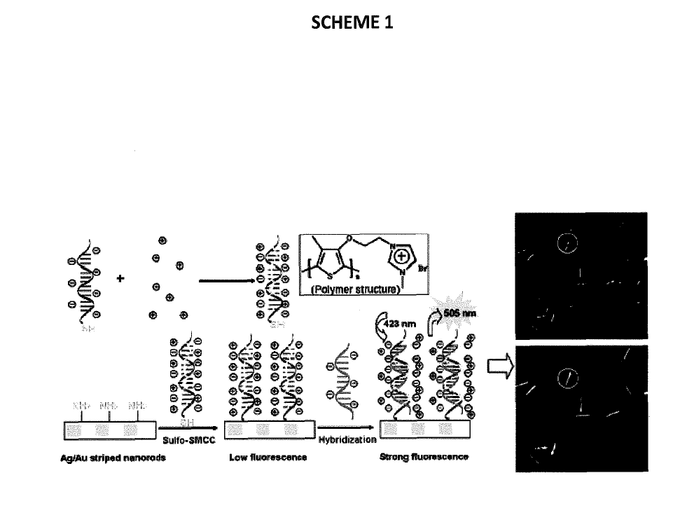

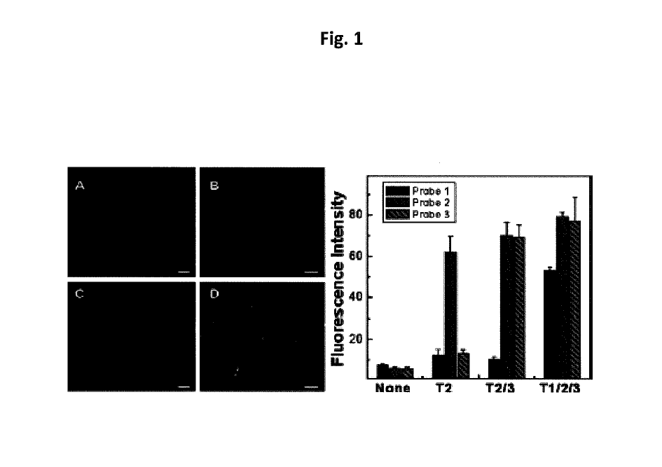

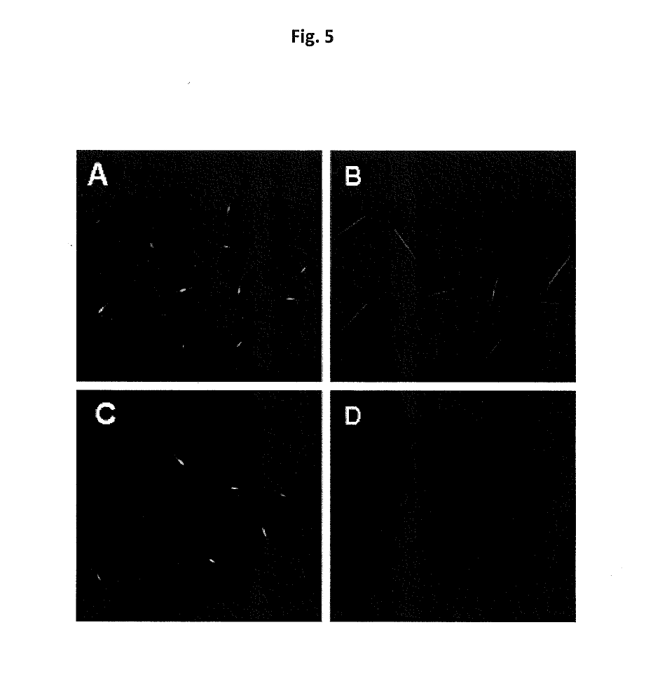

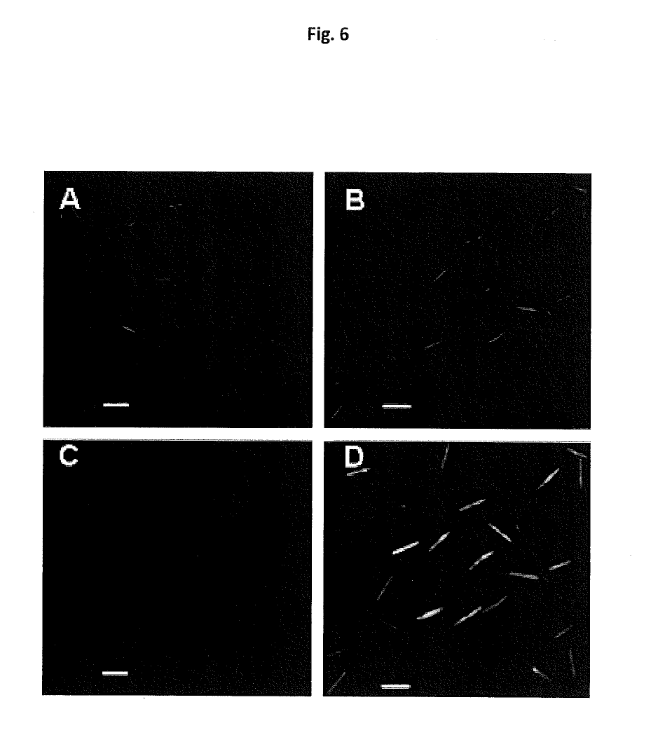

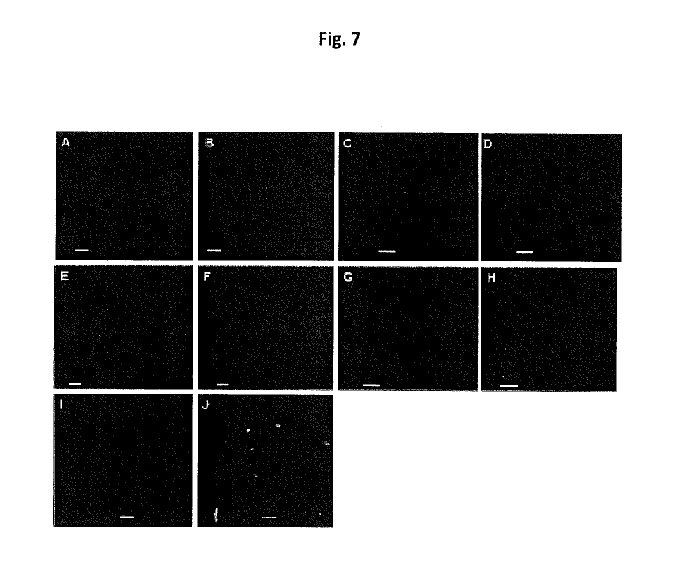

FIG. 1 shows the reflectance and fluorescence images collected from four DNA hybridization assays. Nanorods of three striping patterns were clearly distinguishable in the mixture in all reflectance images (upper panels). The assay results were determined based on the fluorescence readouts (lower panels). In all cases, significant fluorescence intensity was only observed from the nanorod(s) with the capture probe(s) complementary to the target(s) in the incubation solution. Much weaker background was observed from particles with ssDNA-polymer duplex-only on the surface. For example, when the particle mixture was incubated with the solution containing target DNA T2 (SEQ ID NO: 9), only P2-coated particles (01010; SEQ ID NO: 2) displayed strong fluorescence, whereas the other two nanorod patterns (000100 and 011110) showed little fluorescence (FIGS. 1A-B). Similarly, when the particle mixture was incubated with a solution containing targets DNA T2 (SEQ ID NO: 9) and T3 (SEQ ID NO: 10), both P2- and P3-coated particles (01010 and 011110; SEQ ID NOs: 2 and 3, respectively) displayed strong fluorescence, whereas the P1-coated nanorods (000100; SEQ ID NO: 1) remained silent (FIGS. 1C-D). All three types of nanorods showed strong fluorescence signals when all three target DNAs were present in the hybridization solution, whereas no fluorescence signal was measurable when all three targets were absent (FIGS. 5-7). Quantitative readouts of fluorescence intensities from each particle pattern after incubating with solutions containing different DNA targets are summarized in FIG. 1. Unambiguous detection of the presence of target DNA was observed.

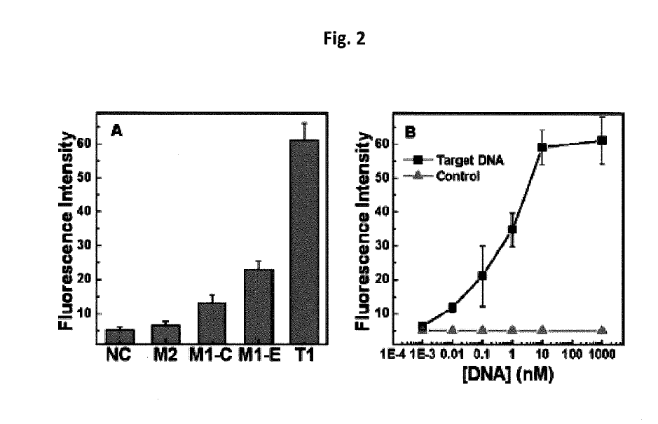

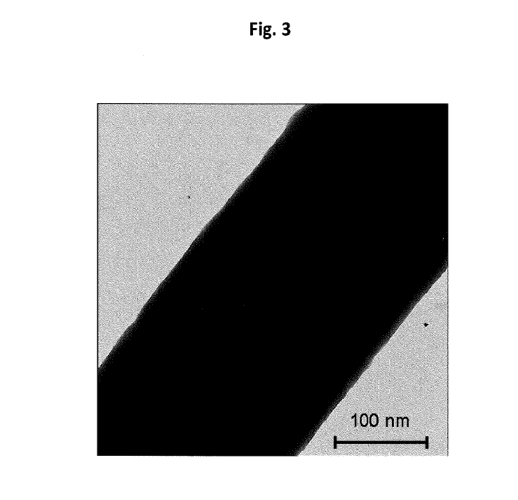

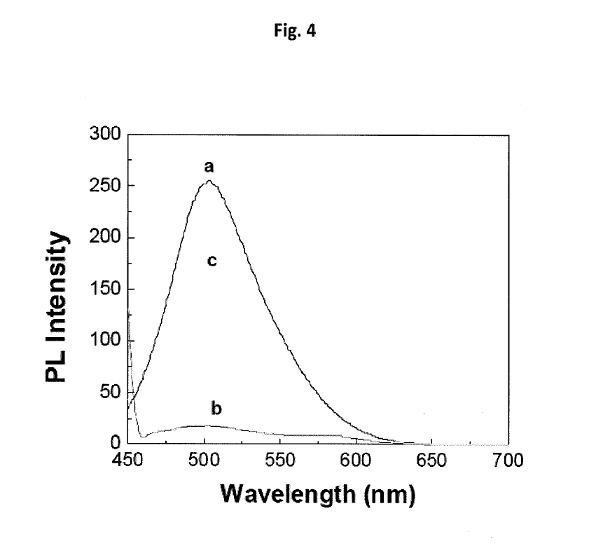

The conjugated polymer-based label-free DNA assay specificity was examined by mixing ssDNA-polymer duplex-bound nanorods with target DNA sequences having mutations at various sites. As shown in FIG. 2A, DNA target (T1: 5′-GAGGGATTATTGTTA-3′; SEQ ID NO: 4) of the perfectly matched sequence produced the strongest fluorescence signal over background. Without extensive optimization, the fluorescence intensity was 12-fold stronger than what was observed from a sequence with two mutations (M2: 5′-GAAGGATGATTGTTA-3′; SEQ ID NO: 7) and a non-complementary sequence (NC: 3′-GGTTGGTGTGTTTGG-5′; SEQ ID NO: 8). The target DNA T1 (SEQ ID NO: 4) had fluorescence intensity 4-fold stronger than a sequence with a single mismatch base at the center (M1-C: 5′-GAGGGATGATTGTTA-3′; SEQ ID NO: 6), and 3-fold stronger than the one with a single mismatch at the 3′-terminus (M1-E: 5′-GAAGGATTATTGTTA-3′; SEQ ID NO: 5). These results demonstrated that the assay specificity is comparable to other methods reported in the literature, including studies where DNA mutations were identified using molecular beacons or surface plasmon resonance. Lin et al. (2008) Nucleic Acid Res. 36, e123; Carrascosa et al. (2009) Anal. Bioanal. Chem. 393, 1173-1182.

The conjugated polymer-based label-free DNA assay using barcoded nanorods is comparable to conventional multiplexed DNA assays. Smith et al. (1998) Clin. Chem. 44, 2054-2058; Stoermer et al. (2006) J. Am. Chem. Soc. 128, 16892-16903. As shown in FIG. 2B, the fluorescence intensities from dsDNA-polymer coated nanorods were logarithmically correlated to the concentration of target DNA. The calculated limit of detection (LOD) was approximately 5 pM. For a typical assay volume of 10 μL, this translates to a detection limit of 50 attomoles, which corresponds to 3×10⁷ molecules. Improvements in LOD may be achievable by reducing the amount of barcoded nanorods during incubation. The fluorescence signal leveled off at 10 nM, and indicates a 3-order of magnitude dynamic range. Note that this dynamic range is tunable to suit different application needs by adjusting the number of nanorods incubated with the target DNA molecules.

FIG. 5 shows the fluorescence detection of label-free DNA on nanorods of the pattern 000100, where 0 and 1 refer to Au and Ag strips, respectively. When illuminated at 490 nm, the Ag and Au strips were distinguishable in the reflectance images, because the Ag strips shows higher reflectance. The nanorods were bound with the capture probe (P1: 5′-TAACAATAATCCCTCA₂₀-3′-SH; SEQ ID NO: 1). Hybridization with the complementary target (T1: 5′-GAGGGATTATTGTTA-3′; SEQ ID NO: 4) led to strong fluorescence emission at 505 nm at the particle surface due to formation of dsDNA-polymer triplex species. Complexes were irradiated at 490nm for reflectance images and 423 for fluorescence images. Weak fluorescence was barely discernable from the background, as imaged for the same particles incubated with a non-complementary DNA sequence (NC: 5′-GGTTGGTGTGGTTGG-3′; SEQ ID NO: 8). The scale bar in all images is 5 μm.

### Cancer Marker Detection Using Fluorescent Conjugated Polymers and Barcoded Nanorods

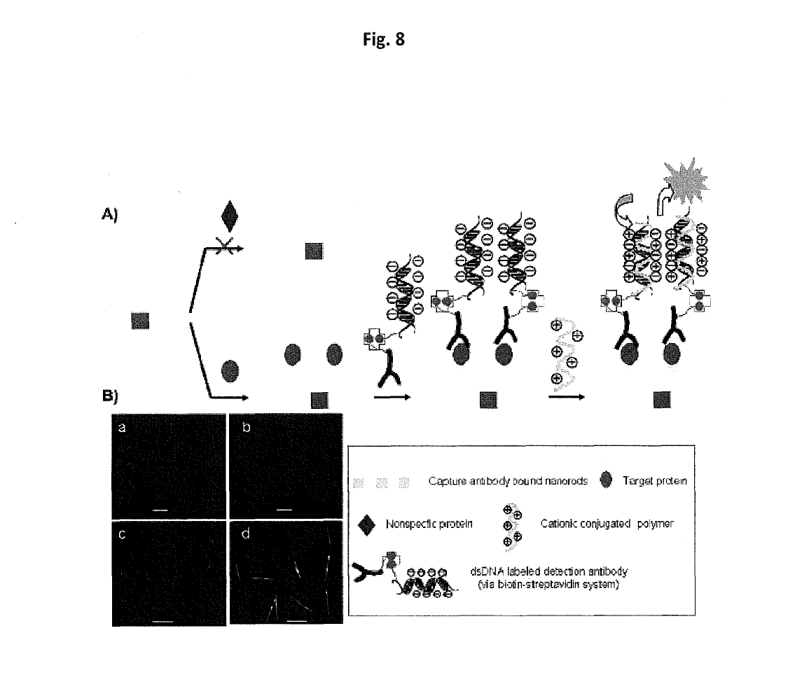

FIG. 8A illustrates the overall detection strategy for one aspect of the invention. Barcoded nanorods with different Au/Ag striping patterns were used as array elements where the particle identity was encoded by the difference in the reflectivity of adjacent metal strips. The nanorods were functionalized with specific antibodies that recognize the target antigen. In the presence of the target antigens, the antigens were captured from the solution by the antibody bound nanorods. The antigen-target-nanorods were then sandwiched by antibody-dsDNA complexes that can bind the target antigens at different epitopes. When cationic fluorescent conjugated polymers were added, they interact with the dsDNA-antibody complex and form dsDNA/polymer triplexes through electrostatic interactions. After washing to remove non-specific absorption of polymers, the triplexes produce strong fluorescence upon excitation on 423 nm. In contrast, when a non-specific protein (BSA) was added, no antibody binding occurred and therefore there was no dsDNA available for interaction with the cationic polymers. Consequently, the cationic conjugated polymers would not bind and no fluorescence was observed from the nanorods. The assay was quantified by acquiring both the reflectance and fluorescence images of nanorods, where the identity of target antigen was determined by the pattern of the nanorods, and the amount of the target antigen captured was quantified based on the fluorescence intensity measured from the nanorods.

The study used a pattern of nanorods (000100) modified with a capture antibody to PSA. As shown in FIG. 8 B, when the anti-PSA bound nanorods were incubated with 1 μg/mL of PSA antigen, significant fluorescence was observed from the nanorods (FIG. 8 B c, d). In contrast, weak, near background fluorescence was observed after the addition of the same concentration of a nonspecific protein, bovine serum albumin (BSA) (FIG. 8 B a, b). The 8-fold increase of fluorescent intensity in the presence of PSA antigen over a BSA control demonstrated the specific binding of PSA antigen to the capture antibody bound nanorods and illustrated that the conjugated polymer based detection method could be used to distinguish the specific protein-binding signals from background fluorescence.

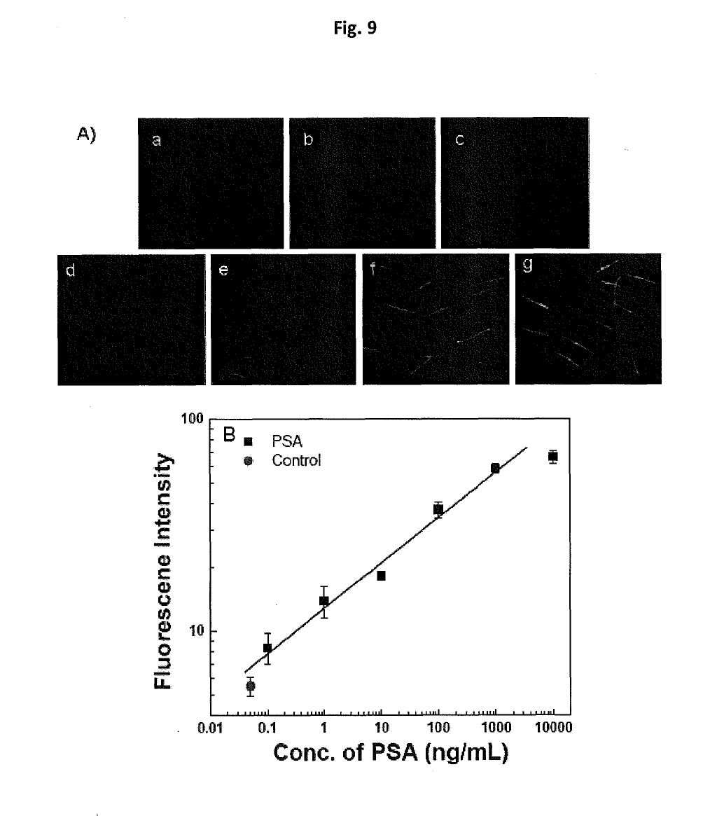

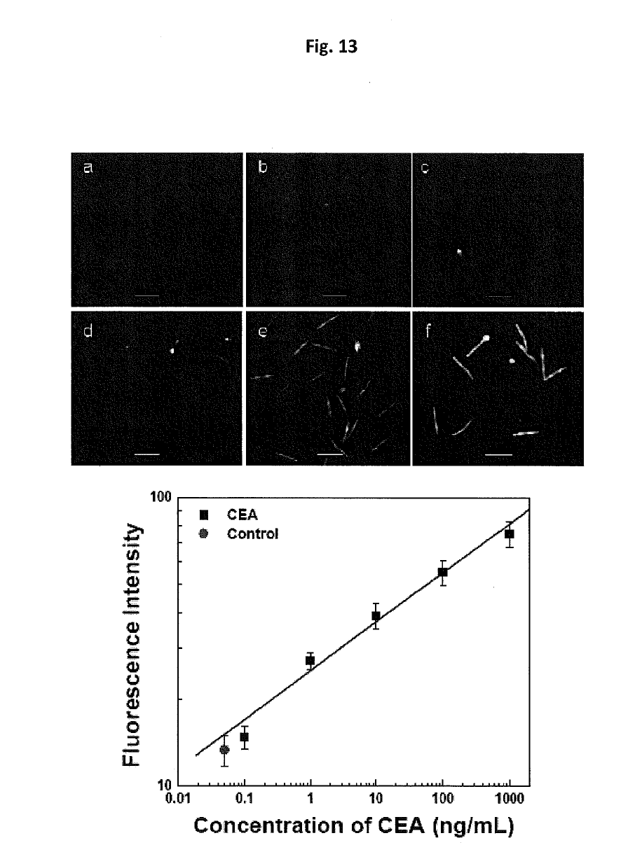

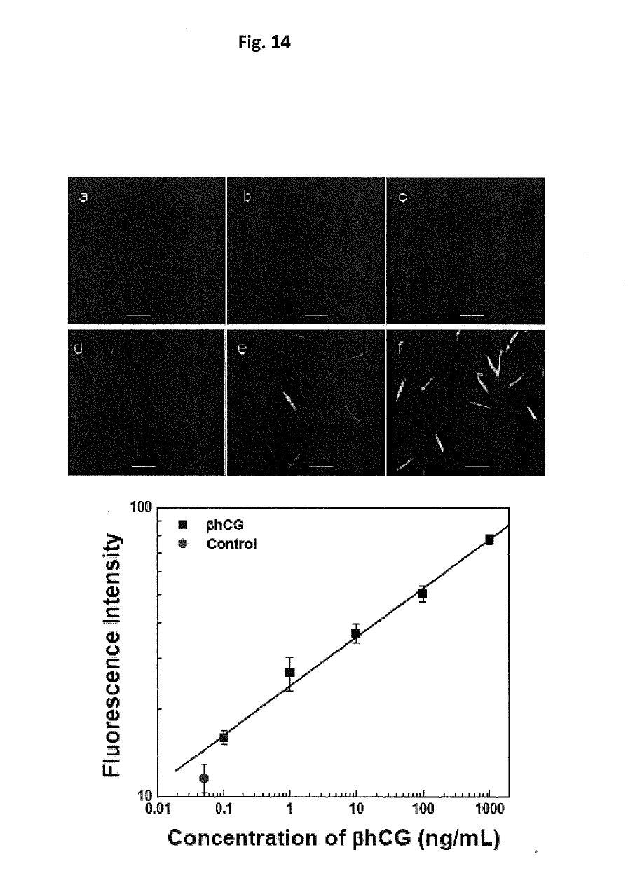

The detection limit of the conjugated polymer assay platform was determined by measuring the fluorescence intensity changes on the nanorods as the solution concentration of PSA was varied and in comparison to a negative control, zero point. Representative fluorescence images showed significant increases in fluorescence intensity as the concentration of PSA antigen increased (FIG. 9). A plot fluorescence intensities versus concentration of PSA antigen showed that the fluorescence intensities were directly proportional to the solution PSA concentration for values form 1000 ng/mL to 0.1 ng/mL. The dynamic linear range of the assay overlaps with the physiologically relevant range of PSA in biological samples. The accepted prostate cancer diagnostic threshold for serum PSA 4 ng/mL. Healy et al. (2007) Trends. Biotechnol. 25, 125-131. The limit of detection (LOD) for PSA in the barcoded nanorod polymer assay, which is defined at three standard deviations above background (i.e., 3σ), was 0.16 ng/mL. This value is significantly below the diagnostic threshold. In this assay, the LOD corresponds to approximately 25 PSA molecules on each nanorod particle. The sensitivity can be attenuated by decreasing the amount of nanorods used in each assay. Similar detection limits were achieved in studies with CEA (0.21 ng/mL), and βhCG, (0.08 ng/mL) (FIGS. 13-14), using nanorods bound with capture antibodies for CEA and βhCG, respectively. Both the CEA and βhCG assay detection limits were below the corresponding disease diagnostic thresholds, which are 2.5 ng/mL for CEA and 3 ng/mL for βhCG, respectively. Baron et al. (2005) Cancer Epidemiol. Biomarkers Prey. 14, 306-318; Mann et al. (1993) J. Clin. Lab. Invest. 216, 97-104.

### Multiplexed Detection of Different Cancer Markers Using Fluorescent Conjugated Polymers and Barcoded Nanorods

Simultaneous detection of numerous cancer markers in a single assay can increase the efficiency, cost, and specificity of cancer diagnostics. To demonstrate the multiplex capability of fluorescent conjugated polymers in conjunction with barcoded nanorods for multiplexed detection of protein markers relevant to cancer, three cancer marker proteins were assayed simultaneously.

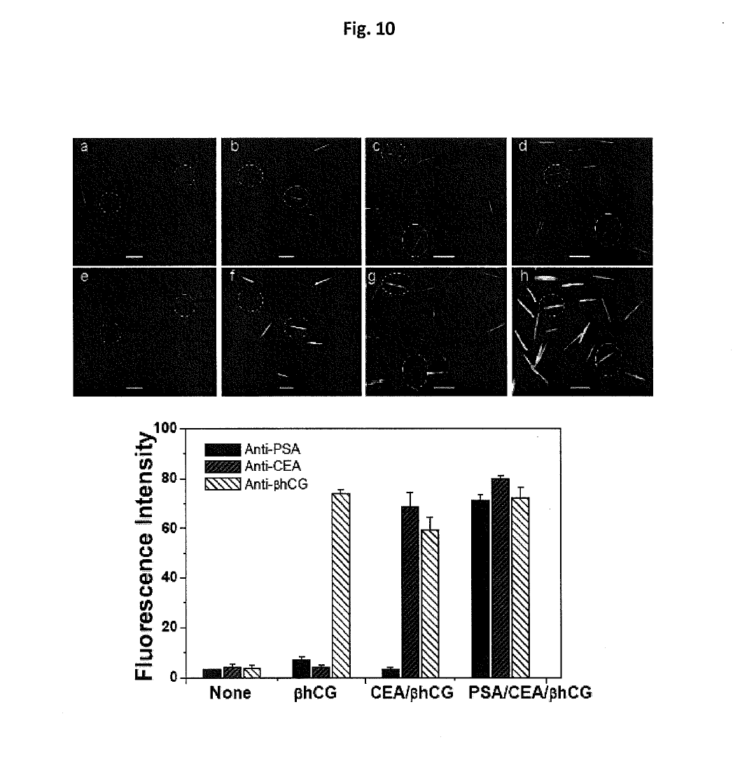

Three barcoded nanorod patterns were created and bound with antibodies for PSA, CEA and βhCG. After the capture antibodies were bound, the individual target antigens and combinations of the target antigens were assayed. The reflection and fluorescence images of three different patterns of nanorods were taken simultaneously as different combination of target antigens were introduced (FIG. 10). The three-nanorod striping patterns were clearly distinguishable among the mixture in reflectance images. Assay results were determined based on the fluorescence intensities measured from the nanorods. A series of four assays were conducted where the presences of different target antigens were varied. One assay examined the fluorescence resulting from the binding of a target antigen alone (without the other two antigens). The other assays examined the combination of one, two, and all three target antigens. In all cases, significant fluorescence intensity was only observed from the nanorods bound with capture antibody specific to the correct target antigens. Much weaker background fluorescence was observed from non-specific binding. For example, when the nanorod mixture was incubated with the solution containing βhCG antigen, only anti-βhCG bound nanorods (011110) displayed strong fluorescence, while the other two nanorod patterns (000100, 01010) showed near background fluorescence (FIG. 10 b, f). Similarly, when the nanorod mixture incubated with a solution containing CEA and βhCG, both anti-CEA and anti-βhCG bound nanorods (01010 and 011110) displayed strong fluorescence; whereas the anti-PSA bound nanorods (000100) remained silent (FIG. 10 c, g). All three types of nanorods displayed strong fluorescence signals when all three target antigens were present in the solution.

However, no fluorescence signal was detectable when all three target antigens were absent (FIG. 10 a, e, d, h). Quantitation of the fluorescence intensity from each nanorod pattern after incubation with different combinations of target antigens is show in the lower panel of FIG. 10. The differences in the fluorescence intensity of the signals may be related to the differences in the binding constants (Kₐ) of the antibodies with their corresponding antigens. These results demonstrated multiplexed cancer markers detection with essentially complete selectivity.

### Cancer Marker Detection in Bovine Serum

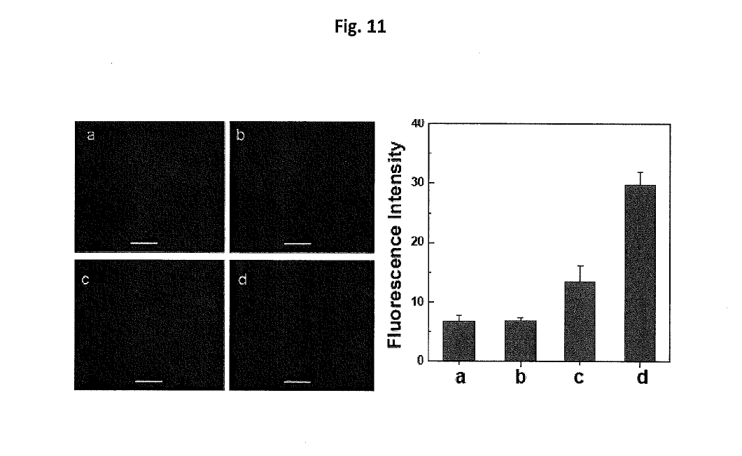

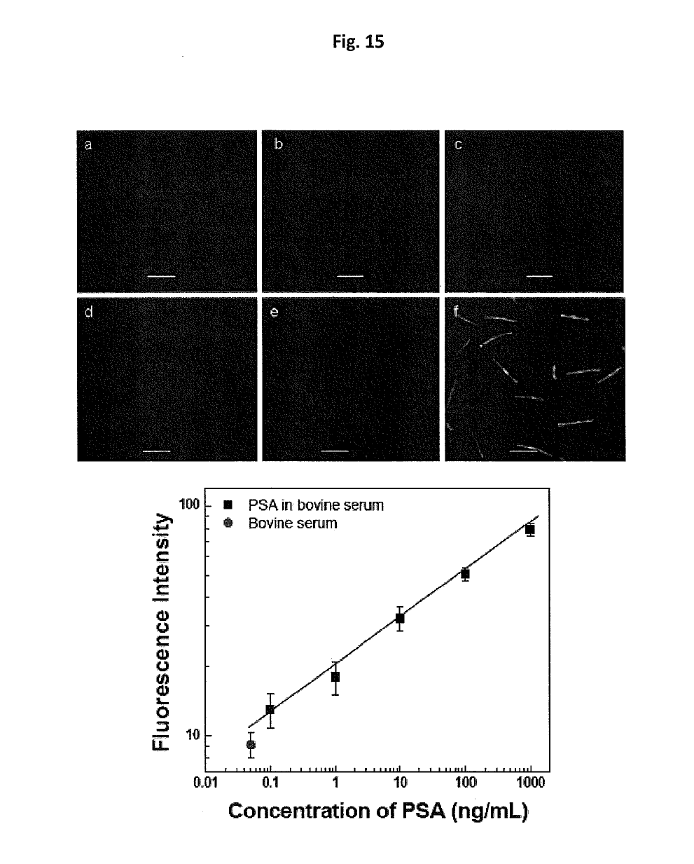

In order for the fluorescent conjugated polymers and barcoded nanorods assay system to be commercially viable, the assay must be capable of analyzing actual biological samples such as blood serum. In order to test this aspect of the invention, detection of PSA in undiluted bovine serum was performed. Generally, serum PSA levels in the range 4-10 ng/mL are indicative of the presence of prostate carcinoma. Healy et al. (2007) Trends Biotechnol. 25, 125-131. The present study tested two bovine serum samples containing 1 and 10 ng/mL of PSA, respectively. FIG. 11 showed the results along with bovine serum and PBS buffer as negative controls. Bovine serum alone does not cause appreciable increases in fluorescence intensity relative to the PBS buffer. This indicates the matrix effects of sera can be ignored. Significant fluorescence intensity was observed for bovine serum samples containing PSA concentrations of 1.0 ng/mL and 10 ng/mL, which were approximately 2- and 4-fold increases, respectively, relative to the negative control. The sensitivity of PSA detection in the bovine serum was also determined by measuring the change in fluorescence intensity as a function of the PSA concentration in bovine sera samples (FIG. 15). The limit of detection for PSA in bovine sear was determined to be 0.08 ng/mL.

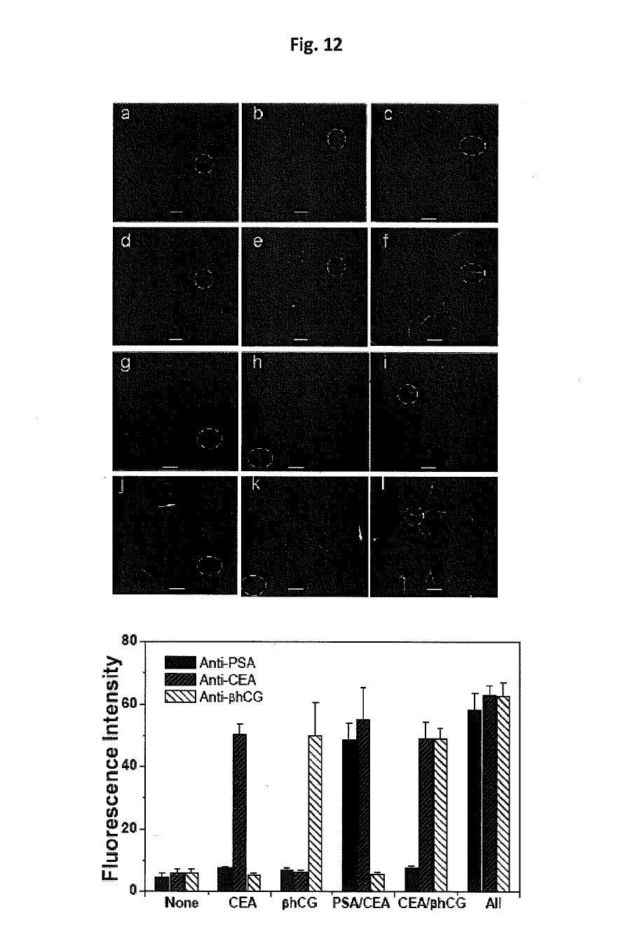

Multiplexed detection of cancer marker proteins in the bovine serum was further investigated. Similarly, assorted nanorods carrying three different capture antibodies for PSA, CEA, and βhCG were mixed and then tested with different combination of target antigens diluted in the bovine serum. FIG. 12 shows the results of six different combinations of three target antigens.

These results demonstrate multiplexed detection of cancer markers with selectivity in bovine serum.

### EXAMPLES

Persons of ordinary skill in the art will recognize that the present invention can be implemented in a number of aspects. Some non-limiting examples of methods are illustrated. Numerous modifications and adaptations thereof will be apparent to those skilled in the art without departing from the spirit and scope of the invention.

### Example 1

### Cationic Fluorescent Conjugated Polymers

The cationic fluorescent conjugated polythiophene polymers used in one aspect of this invention, poly(1-methyl-3-[2-[(4-methyl-3-thienyl)oxy]-ethyl]-1H-imidazolium), were prepared according to the published procedure. Ho et al. (2002) Angew. Chem. Int. Ed. 41, 1548-1551; Dore et al. (2004) J. Am. Chem. Soc. 126, 4240-4244.

### Example 2

### Preparation of Barcoded Nanorods

Silver and gold (Au/Ag) striped nanorods patterned with 000100, 01010, and 011110, where 0 represented a 1-μm segment of Au and 1 represents a 1-μm segment of Ag, were synthesized according to methods in the literature. Reiss, et al. (2002) J. Electroanal. Chem. 522, 95-103; Nicewarner-Peña et al. (2003) J. Phys. Chem. B 107, 7360-7367. The nanorods were precoated with a layer of 20-nm silica and the surfaces were functionalized with amine moieties. Sioss et al. (2007) Langmuir 23, 11334-11341. Capture and detection monoclonal antibody pairs, specific for PSA, CEA, and βhCG, were purchased from Biodesign (Saco, Mass.). Cancer marker antigens, PSA, CEA, βhCG, and bovine serum were also purchased from Biodesign. Streptavidin, bovine serum albumin (BSA), and glutaraldehyde were purchased from Sigma Aldrich (St. Louis, Mo.). Sulfo-NHS-Biotin was obtained from Pierce (Rockford, Ill.). Biotinylated DNA duplex, 5′-Bio-AAATAACAATAATCCCTCGAGCG-3′ (SEQ ID NO: 11) and 5-CGCTCGAGGGATTATTGTTA-3′ (SEQ ID NO: 12) were purchased from Integrated DNA Technologies (Coralville, Iowa).

### Example 3

### Lable-Free Multiplex DNA Detection

One example of an aspect of the present invention is as follows. The multiplexing assay concept was demonstrated using barcoded nanorods of 3-different patterns. Three different thiolated DNA capture probes, P1 (5′-TAACAATAATCCCTCA₂₀-SH; SEQ ID NO: 1), P2 (5′-CACATCGTATCCTAGT₂₀-SH; SEQ ID NO: 2), and P3 (5′-GGCAGCTCGTGGTGAA₂₀-SH; SEQ ID NO: 3), were mixed with conjugated polythiophene derivatives in stoichiometric quantity in separate solutions. The formed ssDNA-polymer duplexes were then coupled to the silica-coated nanorods with patterns of 000100, 01010, or 011110, respectively, where 0 refers to Au strips and 1 to Ag strips. DNA capture probes were linked to the silica coated nanorods by mixing 50 μL of cationic conjugated polymer (˜700 μM) stoichiometrically on a repeat unit basis with 50 μL of capture DNA probe (20 μM) in order to form DNA-polymer complexes. The silica-coated nanorods were modified with amino group by adding 15 μL of APTMS into 150 μL of silica-coated nanorods and 235 μL of ethanol. The mixture was incubated with shaking for 30 min and then rinsed three times with ethanol and two times with 10 mM CHES Buffer (pH 9.0). A solution of 1 mg of sulfo-SMCC (Sulfosuccinimidyl 4-[N-maleimidomethyl] cyclohexane-1-carboxylate) in 400 μL of CHES buffer was added into the nanorods and incubated with shaking for 1 h. After rinsing the nanorods twice with CHES buffer and twice with 10 mM sodium phosphate buffer, pH 7.4 (PB), the pre-formed polymer/DNA duplexes were added into the nanorod solution and incubated with shaking for 1 h, followed by three rinses in PB buffer and re-suspended in 400 μL of PB buffer. The ssDNA-polymer duplex-bound particles were then mixed together and dispensed into separate tubes before being incubated with target DNAs in different mixtures. Similar assay performance was obtained when the capture DNA probes were immobilized on the corresponding particles first, followed by formation of ssDNA-polymer complexes.

### Example 4

Immobilization of Capture Antibodies onto Barcoded Nanorods

The functionalized surface of amine groups on the silica coated nanorods allowed them to attach primary amine groups of capture antibody using dialdehyde chemistry. Briefly, 400 μL of amine-functionalized nanorods (˜4×10⁷ particles) were washed twice with phosphate buffered saline (PBS, i.e., 137 mM NaCl, 2.7 mM KCl, 10 mM Na₂HPO₄, 2 mM KH₂PO₄, pH 7.4) and then resuspended in 240 μL of PBS and 160 μL of 25% glutaraldehyde. The reaction mixture was mixed for 2 hr. After washing with PBS for three times, the particles were resuspended in 400 of PBS and mixed with 20 μL 1 mg/mL capture antibody and allowed to mix for 3 hr. The particles were washed with PBS three times and then 400 μL of 0.1% BSA in PBS (v/v %) was added for blocking; the solution was mixed for 1 hr. The particles were again washed three times with PBS and finally resuspended in 400 μL of 0.1% BSA in PBS and stored at 4° C. Three different patterns of Au/Ag barcoded nanorods (000100, 01010, or 011110, where 0 represents a 1-μm segment of Au and 1 represents a 1 μm of Ag) were bound with the specific capture antibody for each cancer marker protein, PSA, CEA, and βhCG, respectively.

### Example 5

### Preparation of Biotinylated Antibodies

A mixture of 20 μL of 5 mg/mL detection antibody, 4 μL of 1.4 mg/mL sulfo-NHS-Biotin, 5 μL of 1.0 M Na₂CO₃/NaHCO₃ buffer (pH 9.0), and 21 μL of H₂O were mixed and stirred for 2 hr at room temperature. The product was then purified using a Micro Bio-Spin column from Bio-Rad (Hercules, Calif.).

### Example 6

### Preparation of Biotinylated Antibody-dsDNA Complexes

A 15-μL aliquot of 0.4 mg/mL prepared biotinylated antibody was mixed with 20 μL of 0.1 mg/mL streptavidin and 453 μL of PBS and stirred for 2 hr. The mixture was then combined with 12 μL of 10 μM of biotinylated ds-DNA (base-paired SEQ ID NOs: 11 and 12) and stirred for an additional 2 hr. The prepared antibody-dsDNA complex was used in the assay without further purification.

### Example 7

### Cancer Marker Detection on Barcoded Nanorods

A 30-μL aliquot of each specific antibody-bound nanorod suspension was washed twice with PBS, and was mixed with 30 μL of the corresponding antigen samples. The concentration ranges of the antigen tested were prepared in the PBS as following: 0, 0.1, 1, 10, 100, 1000 and 1×10⁴ ng/mL. The mixtures were incubated for 1 hr at room temperature. The particles were then washed twice with 0.1% Tween 20 in PBS (PBST) and resuspended in 30 μL of 10 μg/mL biotinylated antibody-dsDNA complexes, and allowed to incubate for another 1 hr. After two additional washes in PBST and 10 mM sodium phosphate buffer, pH 7.4 (PB), the particles were incubated with 30 μL of PBS mixed with 1 μl. of cationic conjugated polymers (˜750 μM in repeated unit) for 30 min. The particles were then washed twice with PBST, and resuspended in 30 μL of 10 mM PB for imaging analysis.

### Example 8

### Multiplexed Detection of Cancer Markers

A 10-μL aliquot of each stock solution of capture antibody-bound nanorods was mixed and washed twice with PBS. The multiplexed assay was initiated by adding 30 μL of the target antigen in PBS. The concentrations of the target antigens remained constant for all experiments (100 ng/mL). The mixture was incubated for 1 hr at room temperature. The particles were then washed twice with PBST and resuspended in 30 μL of a mixture of three detection antibody-dsDNA complexes (10 μg/mL in PBS each), and incubated for another 1 hr. After washing two times with PBST and two times with 10 mM PB, the particles were incubated with 30 μL of PB mixed with 1 μL of cationic conjugated polymers (˜750 μM in repeated unit) for 30 min. The particles were then washed twice with PBT and resuspended in 30 μL of 10 mM PB for imaging analysis.

### Example 9

### Detection of Cancer Markers in Bovine Serum

Samples were prepared by adding the appropriate target antigens to undiluted bovine serum. The assay was initiated by adding 30 μL of antigen(s) contained serum sample into capture antibody-bound nanorods. Further, the assay was carried out under conditions similar to the ones used in the buffer solution.

### Example 10

### Sample Imaging and Data Analysis

A 10-μL aliquot of each nanorod sample was dropped onto a glass slide and the particles were allowed to settle for at least 2 min, followed by placing a coverslip over the sample. The particles were imaged using a Zeiss Axivert 35 inverted fluorescence microscope equipped with a brightfield reflectance filter set (Chroma, D495/40X, Q660DCLP dichroic, and 0.3 ND) for reflectance imaging of nanorods, and a fluorescence filter set (Chroma, D405/40X excitation, Q460DCLP dichroic, and HQ510/50M emission) for fluorescence imaging of conjugated polymers bound to the nanorods. All images were acquired using a 63× oil immersion lens. The fluorescence intensity was analyzed using Image J analysis software (NIH).

1. A method for detecting nucleic acid hybridization comprising:
(a) combining together to form a hybridization reporter complex comprising:
(i) a nucleic acid target molecule;
(ii) a nucleic acid probe;
(iii) a flexible cationic conjugated fluorescent polymer; and
(iv) a barcoded particle;
(b) irradiating the hybridization reporter complex with light; and
(c) detecting fluorescence emission to detect nucleic acid hybridization.

2. The method of claim 1, wherein the flexible cationic conjugated fluorescent polymer is poly(1-methyl-3-[2-[(4-methyl-3-thienyl)oxy]-ethyl]-1H-imidazolium) or a derivative thereof.

3. The method of claim 1, wherein the nucleic acid target molecule is selected from the group consisting of DNA, RNA, and a modified nucleic acid.

4. The method of claim 1, wherein the nucleic acid probe is selected from the group consisting. of DNA, RNA, and a modified nucleic acid.

5. The method of claim 1, wherein the nucleic acid target molecule is complementary to the nucleic acid probe.

6. The method of claim 1, wherein the nucleic acid target molecule, nucleic, acid probe, and flexible cationic conjugated fluorescent polymer form a triplex structure.

7. The method of claim 1, wherein the nucleic acid probe covalently binds to the barcoded particle.

8. The method of claim 1, wherein the barcoded particle is striped with a plurality of metals consisting of copper, nickel, ruthenium, rhodium, palladium, silver, osmium, iridium, platinum, or gold in a predetermined pattern.

9. The method of claim 1, wherein, the barcoded particle is sniped with silver and gold in a predetermined pattern

10. The method of claim 1, wherein the hybridization reporter complex is irradiated with light having wavelengths between 350-500 nm and the fluorescence emission is detected at wavelengths between 400-650 nm,

11. The method of claim 1, wherein the reporter complex is irradiated with light at 423 nm and the fluorescence emission is detected at 505 nm.

12. The method of claim 1, wherein the fluoresence emission can be detected by an instrument selected from the group consisting of a fluorometer, a fluorescence microscope, and a high throughput fluorescence detector, a fluorescence plate reader, an array chip scanner, and a handheld fluorescence reader.

13. The method claim 1, wherein hybridization can be detected for a plurality of nucleic acid target molecules simultaneously.

14. The method of claim 1, wherein the nucleic acid target molecule can be quantified.

15. The method of claim 1, wherein the nucleic acid target molecule is from a biological fluid.

16. A method for detecting a disease state, comprising the method of claim 1, wherein the nucleic acid target molecule comprises one or more single nucleotide polymorphisms (SNPs).

17. A hybridization reporter complex. comprising a nucleic acid target molecule; a nucleic acid probe; a flexible cationic conjugated fluorescent polymer; and a barcoded particle;
wherein the nucleic acid target molecule is complementary to the nucleic acid capture probe;
wherein the nucleic acid target molecule, nucleic acid capture probe, and flexible cationic conjugated fluorescent polymer form a triplex structure;
wherein the nucleic acid probe covalently binds to the barcoded particle;
wherein, the barcoded particle is striped with silver and gold in a predetermined pattern; and
wherein the flexible cationic conjugated fluorescent polymer is poly(1-methyl-3-[2-[(4-methyl-3-thienyl)oxy]-ethyl]-1H-imidazolium) or a derivative thereof.

18-37. (canceled)

38. A kit for detecting nucleic acid hybridization comprising a container comprising individual premeasured containers of reagents, the containers including at least a nucleic acid probe specific for a. nucleic. acid target molecule, a cationic conjugated fluorescent polymer, a barcoded particle, and instructions describing a method for detecting nucleic acid hybridization, the method comprising:
(a) combining together to form a hybridization reporter complex comprising:
(i) a nucleic acid target molecule;
(ii) a nucleic acid probe;
(iii) a flexible cationic conjugated fluorescent polymer; and
(iv) a barcoded particle;
wherein the nucleic acid target molecule is complementary to the nucleic acid capture probe;
wherein the nucleic acid target molecule, nucleic acid capture probe, and flexible cationic conjugated fluorescent polymer form a triplex structure;
wherein the nucleic acid probe covalently binds to the barcoded particle;
wherein, the barcoded particle is striped with silver and gold in a predetermined pattern; and
wherein the flexible cationic conjugated fluorescent polymer is poly(1-methyl-3-[2-[(4-methyl-3-thienyl)oxy]-ethyl]-1H-imidazolium) or a derivative thereof;
(b) irradiating the hybridization reporter complex with light; and
(c) detecting fluorescence emission to detect nucleic acid hybridization.

39. A kit for detecting a disease state_{;} comprising the kit of claim 38, wherein the nucleic acid target molecule contains one or more single nucleotide polymotphisms (SNPs).

40-41. (canceled)
